(19) United States
(12) Patent Application Publication
(10) Pub. No.: US 2021/0243999 A1
(43) Pub. Date: Aug. 12, 2021

(54) PET DRYING JACKET

(71) Applicant: Jaehyun PARK, Seoul (KR)

(72) Inventor: Jaehyun PARK, Seoul (KR)

(21) Appl. No.: 17/053,767

(22) PCT Filed: May 7, 2019
(86) PCT No.: PCT/KR2019/005408

§ 371 Date: Nov. 7, 2020

(30) Foreign Application Priority Data
May 8, 2018 (KR) 10-2018-0052338

(51) Int. Cl. A01K 13/00

(52) U.S. Cl. CPC A01K 13/001

(57) ABSTRACT

A pet drying jacket according to one embodiment of the present invention comprises: a body part formed in a sheet shape and having multiple discharge holes formed therethrough; and a supply part formed in a pipe shape and connected to the outer surface of the body part, wherein, in a state in which the body part surrounds a pet such that body openings are formed at opposite side ends of the body part, hot air is supplied to a part between the body part and the pet through the supply part, dries the pet, and then is discharged through the discharge holes and the body openings.

### TECHNICAL FIELD

The present invention relates to a pet drying jacket, and more particularly, to a pet drying jacket that allows a pet to be easily dried after the pet takes a bath.

### BACKGROUND ART

In general, pets such as dogs and cats live indoors with people. Considerable attention has been paid to the cleanliness of such pets. Accordingly, pet owners frequently bathe their pets to remove characteristic smells and odors of the pets and remove germs, mites, dust, and the like included in hairs so as to keep the pets clean.

After bathing the pet, the pet owners use a towel to remove moisture, and apply hot air by using a dryer or the like so as to dry the pets.

However, the pets frequently resist when the pets are wiped with a towel or hot air is applied to the pets with a dryer, so that opposite the pet owners and the pets have been stressed.

In particular, when the pets are dried after taking a bath, the pets may intensely shake their body to remove the moisture from their body portions, which causes hairs to scatter together with water droplets, making surroundings dirty. In addition, since the pets may run away or move much without staying still, considerable time and effort have been required to dry the pets.

### DETAILED DESCRIPTION OF THE INVENTION

### Technical Problem

The technical problem to be solved by a pet drying jacket according to the technical idea of the present invention is to provide a pet drying jacket capable of drying a pet while minimizing a movement of the pet.

In addition, the technical problem to be solved by the pet drying jacket according to the technical idea of the present invention is to provide a pet drying jacket capable of evenly supplying hot air for drying a pet to the pet.

The technical problems to be solved by the pet drying jacket according to the technical idea of the present invention are not limited to the above-described problems, and other problems that are not mentioned above will be clearly understood by those skilled in the art from the following descriptions.

### Technical Solution

According to one embodiment according to the technical idea of the present invention, a pet drying jacket includes: a body part having a sheet shape, and having a plurality of discharge holes; and a supply part having a pipe shape, and connected to an outer surface of the body part, wherein, while the body part surrounds a pet such that body openings are formed at opposite lateral ends of the body part, hot air is supplied between the body part and the pet through the supply part to dry the pet, and discharged through the discharge holes and the body openings.

In addition, the body part may have a rectangular sheet shape, the pet drying jacket may further include: a pair of coupling parts located at opposite longitudinal end portions of the body part, respectively, while being spaced apart from each other; and adjustment parts located at opposite lateral end portions of the body part, respectively, to intersect the coupling parts while being spaced apart from each other, and configured to expand and contract the opposite lateral end portions of the body part, and, while the body part surrounds the pet such that the body openings are formed at the opposite lateral ends of the body part, the coupling parts may be coupled to each other, and the adjustment parts may adjust sizes of the body openings by expanding and contracting the opposite lateral end portions of the body part, respectively.

In addition, the adjustment part may include: adjustment guide parts having a string shape, and located along the opposite lateral end portions of the body part to pass through the body part, respectively; and an adjustment body part through which the adjustment guide part having opposite longitudinal ends connected to each other passes, and configured to expand and contract the opposite lateral end portions of the body part by moving along the adjustment guide part, an adjustment stopper may be located on the adjustment guide part, and, when the adjustment body part makes contact with the adjustment stopper by moving along the adjustment guide part, the adjustment stopper may restrict the movement of the adjustment body part, which contracts the opposite lateral end portions of the body part.

In addition, the pet drying jacket may further include an induction part having a sheet shape, having a plurality of supply holes, and located on an inner surface of the body part to form a supply space connected to the supply part, wherein, while the body part surrounds the pet, the hot air may be supplied to the supply space through the supply part, and supplied between the body part and the pet through the supply hole.

In addition, the pet drying jacket may further include an induction control part located between the supply holes and between the body part and the induction part, having a predetermined width, extending from the induction part so as to be bent away from the supply part, and making contact with the inner surface of the body part, wherein, when the hot air is supplied from the supply part to the supply space, the hot air may flow away from the supply part to reach the induction control part so as to separate the induction control part from the inner surface of the body part, and may pass between the induction control part and the body part.

In addition, the pet drying jacket may further include an induction part having a curved shape corresponding to a curvature of the supply part, located on an inner surface of the body part, and connected to the supply part, wherein, while the body part surrounds the pet, the induction part may be located between the supply part and the pet.

In addition, while the body part surrounds the pet such that the body openings are formed at the opposite lateral ends of the body part, the supply part may be connected to the outer surface of the body part adjacent to the body opening toward which a tail of the pet is directed.

### Advantageous Effects

The pet drying jacket according to embodiments according to the technical idea of the present invention has the following effects.

(1) The pet can be dried while minimizing the movement of the pet.

(2) The hot air for drying the pet can be evenly supplied to the pet.

However, the effects that can be achieved by the pet drying jacket according to one embodiment of the present invention are not limited to the above-described effects, and other effects that are not mentioned above will be clearly understood by those skilled in the art from the following descriptions.

### DESCRIPTION OF THE DRAWINGS

In order to fully understand the drawings recited herein, a brief description of each drawing will be provided.

FIG. 1 is a perspective view showing a pet drying jacket according to a first embodiment of the present invention.

FIG. 2 is a perspective view showing the pet drying jacket according to the first embodiment of the present invention in a different direction.

FIG. 3 is a perspective view showing a state in which the pet drying jacket according to the first embodiment of the present invention is used to dry a pet.

FIG. 4 is a view showing an operation of an induction control part in an induction part when hot air is supplied to the pet drying jacket according to the first embodiment of the present invention.

FIG. 5 is a perspective view showing a state in which the pet drying jacket according to the first embodiment of the present invention includes a modified induction part.

FIG. 6 is a perspective view showing a pet drying jacket according to a second embodiment of the present invention.

### MODE FOR INVENTION

Since various modifications can be made to the present invention, and various embodiments of the present invention can be provided, specific embodiments will be illustrated in the drawings and described in detail through the detailed descriptions. This, however, is by no means to restrict the present invention to the specific embodiments, and the present invention shall be construed as including all modifications, equivalents, and substitutes within the idea and technical scope of the present invention.

In describing the present invention, detailed descriptions of the related art incorporated herein may be omitted when they are determined to make the subject matter of the present invention rather unclear. In addition, ordinal numbers (e.g., first, second, etc.) used herein are merely identification symbols for discriminating one element from another element.

In addition, as used herein, when one element is described as being “connected” or “accessed” to another element, it shall be construed that the one element is directly connected or directly accessed to the other element, but the one element may be connected or accessed to the other element with another element in between unless explicitly described to the contrary.

In addition, as used herein, an element represented by “˜ part” may be configured by combining two or more elements into one element, or may be configured by dividing one element into two or more elements for each subdivided function. In addition, each element that will be described below may additionally perform some or all of functions assigned to other elements in addition to a main function thereof, and some of the main functions assigned to each element may be dedicated and performed by other elements.

Hereinafter, embodiments according to the technical idea of the present invention will be sequentially described in detail.

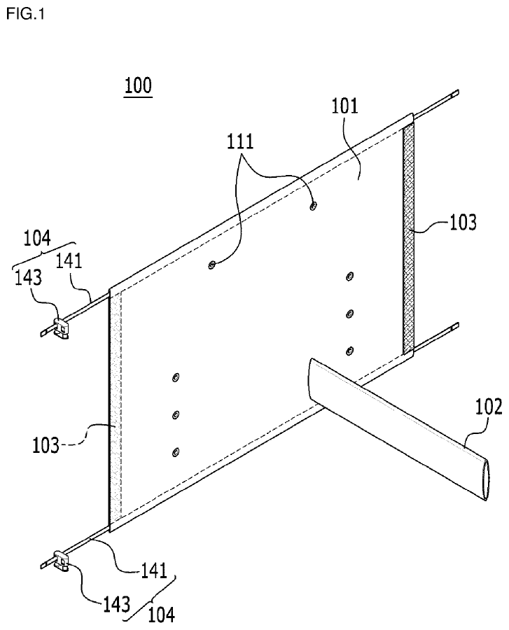

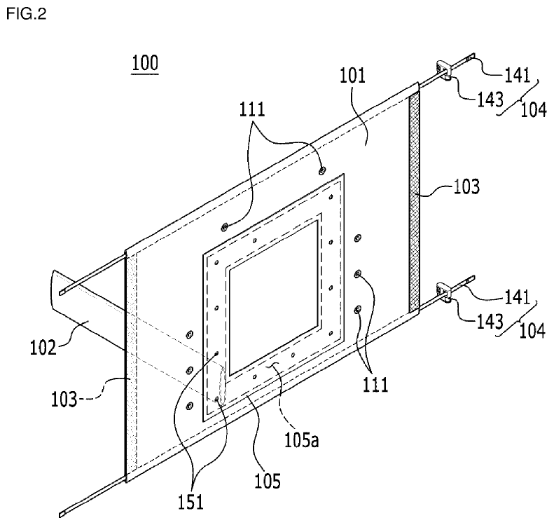

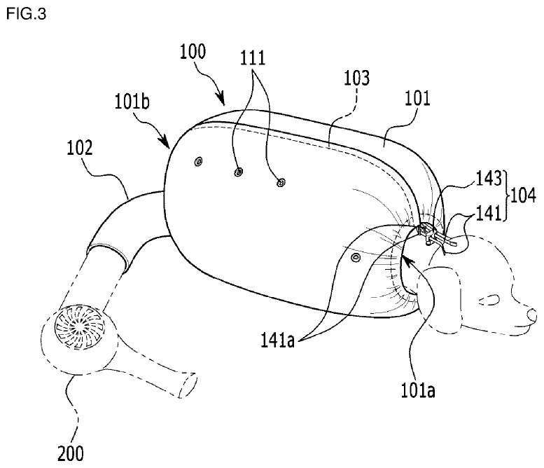

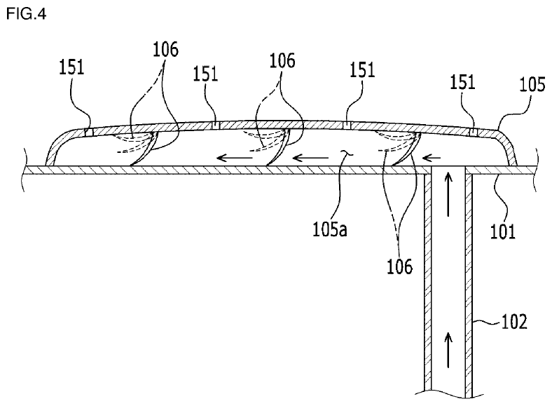

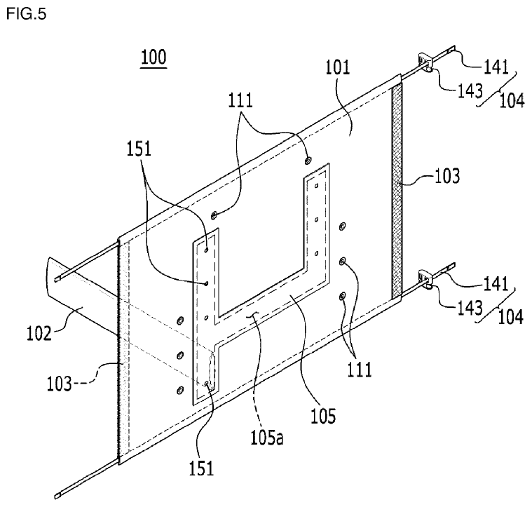

FIG. 1 is a perspective view showing a pet drying jacket 100 according to a first embodiment of the present invention, FIG. 2 is a perspective view showing the pet drying jacket 100 according to the first embodiment of the present invention in a different direction, FIG. 3 is a perspective view showing a state in which the pet drying jacket 100 according to the first embodiment of the present invention is used to dry a pet, FIG. 4 is a view showing an operation of an induction control part 106 in an induction part 105 when hot air is supplied to the pet drying jacket 100 according to the first embodiment of the present invention, and FIG. 5 is a perspective view showing a state in which the pet drying jacket 100 according to the first embodiment of the present invention includes a modified induction part 105.

As shown in FIGS. 1 to 5, a pet drying jacket 100 according to a first embodiment of the present invention may include a body part 101, a supply part 102, a coupling part 103, and an adjustment part 104, and may be used to dry a pet. The pet drying jacket 100 may be used to dry hairs of a bathed pet by using hot air while surrounding the pet, especially a body portion and legs of the pet, and it is particularly preferable to apply the pet drying jacket 100 to a pet after the pet takes a bath. In this case, the pet is preferably a dog, a cat, or the like, but is not limited thereto, and the pet may be various animals that have hairs and are required to be dried after a bath.

The body part 101 may have a sheet shape, and may have a plurality of discharge holes 111. The pet may be located on the body part 101 so as to be surrounded by the body part 101. In this case, opposite longitudinal end portions of the body part 101 may be connected to each other.

The body part 101 preferably has a rectangular sheet shape as shown in the drawings, but is not limited thereto, and the body part 101 may be configured in the form of a sheet having various shapes.

In addition, the body part 101 may be formed of a flexible fibrous material, which may overlap or may be agglomerated. The body part 101 may be formed of a material that does not allow air to pass therethrough, and may be formed of synthetic fibers.

The supply part 102 may have a pipe shape, and may be connected to an outer surface of the body part 101. In this case, the outer surface of the body part 101 refers to a surface of the body part 101 that does not face the pet when the body part 101 surrounds the pet.

In addition, similar to the body part 101, the supply part 102 may also be formed of a flexible fibrous material, which may overlap or may be agglomerated. The supply part 102 may be formed of a material that does not allow air to pass therethrough, and may be formed of synthetic fibers. Air may be supplied to the supply part 102.

A pair of coupling parts 103 may be provided, and may be located at the opposite longitudinal end portions of the body part 101, respectively, while being spaced apart from each other. While the body part 101 surrounds the pet, the coupling parts 103 may be detachably coupled to each other. Accordingly, the pet may be maintained in a state surrounded by the body part 101. In this case, the coupling part 103 may be configured as Velcro, but is not limited thereto, and the coupling part 103 may be configured as various devices that may couple and separate the opposite longitudinal end portions of the body part 101 to and from each other, such as a zipper.

In addition, while the coupling parts 103 are coupled to each other, body openings may be formed at opposite lateral ends of the body part 101, respectively, in which the body opening formed on a front side of the body part 101 will be referred to as a body front opening 101a, and the body opening formed on a rear side of the body part 101 will be referred to as a body rear opening 101b. In this case, while the pet is surrounded by the body part 101, a neck of the pet may pass through the body front opening 101a, and a tail of the pet may be directed toward the body rear opening 101b. In addition, the supply part 102 may be connected to the outer surface of the body part 101 adjacent to the body rear opening 101b toward which the tail of the pet is directed.

A pair of adjustment parts 104 may be provided, and may be located at opposite lateral end portions of the body part 101, respectively, to intersect the coupling parts 103 while being spaced apart from each other. The adjustment part 104 may expand and contract the opposite lateral end portions of the body part 101.

While the body part 101 surrounds the pet and the coupling parts 103 are coupled to each other, the adjustment parts 104 may adjust sizes of the body front opening 101a and the body rear opening 101b by expanding and contracting the opposite lateral end portions of the body part 101, respectively. Since the size of the body rear opening 101b of the body part 101 is adjusted, discharge of the hot air through the body rear opening 101b may be adjusted.

In addition, the adjustment part 104 may include an adjustment guide part 141 and an adjustment body part 143.

The adjustment guide part 141 may have a string shape, and may be located along the opposite lateral end portions of the body part 101 to pass through the body part 101. In this case, opposite longitudinal ends of the adjustment guide part 141 may be connected to each other.

The adjustment body part 143 may be coupled to the adjustment guide part 141, and movable along the adjustment guide part 141. In this case, while the opposite longitudinal ends of the adjustment guide part 141 are connected to each other, the adjustment guide part 141 may pass through the adjustment body part 143. As the adjustment body part 143 moves along the adjustment guide part 141, the opposite lateral end portions of the body part 101 may be expanded and contracted, and the sizes of the body front opening 101a and the body rear opening 101b of the body part 101 may be adjusted. For example, as the adjustment body part 143 moves away from the opposite longitudinal ends of the adjustment guide part 141, the opposite lateral end portions of the body part 101 may be contracted, and the sizes of the body front opening 101a and the body rear opening 101b of the body part 101 may be reduced. Meanwhile, as the adjustment body part 143 approaches the opposite longitudinal ends of the adjustment guide part 141, the opposite lateral end portions of the body part 101 may be expanded, and the sizes of the body front opening 101a and the body rear opening 101b of the body part 101 may be increased.

Meanwhile, an adjustment stopper 141a may be located on the adjustment guide part 141. The adjustment body part 143 may make contact with the adjustment stopper 141a while moving along the adjustment guide part 141 so that the adjustment body part 143 may be prevented from moving away from the opposite longitudinal ends of the adjustment guide part 141. In this case, the opposite lateral end portions of the body part 101 may not be contracted by the adjustment part 104. In other words, the adjustment part 104 may not seal a gap between the body part 101 and the pet.

In particular, the adjustment part 104 may prevent the size of the body rear opening 101b toward which the tail of the pet is directed from being reduced so as to be smaller than a predetermined size. In this case, the predetermined size of the body rear opening 101b refers to a size of the body rear opening 101b that allows a temperature between the body part 101 and the pet to be optimally maintained by the hot air. Accordingly, an increase in the temperature between the body part 101 and the pet and damage to skin of the pet, such as a burn, that may occur when the size of the body rear opening 101b is smaller than the predetermined size may be prevented.

In addition, the adjustment part 104 may prevent the pet from choking, so that the pet may not be uncomfortable while being surrounded by the body part 101.

While the pet is surrounded by the body part 101, a hot air supplier 200 may be connected to the supply part 102 to supply the hot air to the supply part 102. In this case, the hot air supplier 200 may be a device configured to generate hot air and connected to the supply part 102, such as a dryer.

In addition, the hot air may pass through the supply part 102 and may be supplied between the pet and the body part 101 so as to be used to dry the pet, and may pass through the discharge hole 111. The hot air passed through the discharge hole 111 may be discharged to an outside of a space formed by the body part 101. Further, a large amount of hot air may be supplied between the pet and the body part 101, and discharged through the body rear opening 101b of the body part 101. Accordingly, the hot air may be supplied between the pet and the body part 101 without excessively heating the pet so that the damage to the skin of the pet may not be caused, and the hot air may not separate the coupling parts 103 coupled to each other from each other by increasing a pressure between the pet and the body part 101, which may be sealed.

Particularly, when the body part 101 surrounds the pet, the body part 101 surrounds the body portion and the legs of the pet at once, so that a movement of the pet may be restricted. Accordingly, the pet drying jacket 100 of the present embodiment may dry the pet while significantly reducing the time and effort to restrict the movement of the pet.

In addition, the pet drying jacket 100 according to the present embodiment as described above may further include an induction part 105 and an induction control part 106.

The induction part 105 may have a sheet shape, and may have a plurality of supply holes 151. The induction part 105 may be located on an inner surface of the body part 101 to form a supply space 105a. In this case, the inner surface of the body part 101 refers to a surface of the body part 101 facing the pet when the body part 101 surrounds the pet. In addition, the supply space 105a may be connected to the supply part 102. While the body part 101 surrounds the pet, the supply space 105a may be connected between the body part 101 and the pet through the supply hole 151. Meanwhile, the induction part 105 may be located on the inner side of the body part 101 without blocking the discharge hole 111 of the body part 101. In addition, the induction part 105 may have various shapes as shown in FIGS. 2 and 5.

In addition, similar to the body part 101, the induction part 105 may also be formed of a flexible fibrous material, which may overlap or may be agglomerated. The induction part 105 may be formed of a material that does not allow air to pass therethrough, and may be formed of synthetic fibers.

While the body part 101 surrounds the pet, when the hot air supplier 200 is connected to the supply part 102 to supply the hot air to the supply part 102, the hot air may be supplied to the supply space 105a so as to be supplied between the pet and the body part 101 through the supply holes 151 without being directly supplied between the pet and the body part 101. Accordingly, the hot air may be evenly supplied over a plurality of regions of the pet corresponding to the supply holes 151 without being concentrated only at a region of the pet adjacent to a connection portion between the supply part 102 and the body part 101. Therefore, the induction part 105 may evenly supply the hot air to the pet, so that the pet may be dried more evenly, and the damage to the skin of the pet due to concentration of the hot air at a specific region may be prevented.

The induction control part 106 may be located in the supply space 105a, may have a predetermined width, may extend from the induction part 105 so as to be bent away from the supply part 102, and may make contact with the inner surface of the body part 101. In this case, the induction control part 106 may be located between the induction part 105 and the body part 101, and may be located between the supply holes 151 so as to partition the supply space 105a. In addition, the induction control part 106 may be formed of a material that does not allow air to pass therethrough, and may be formed of plastic or synthetic fibers.

When the hot air is supplied from the supply part 102 to the supply space 105a, the hot air may flow away from the supply part 102 to reach the induction control part 106 so as to separate the induction control part 106 from the inner surface of the body part 101. In this case, the hot air may pass between the induction control part 106 and the body part 101, and may spread in the supply space 105a.

When the hot air passes between the induction control part 106 and the body part 101, the hot air may flow at a higher speed as compared with a case where the hot air passes between the body part 101 and the induction part 105. In other words, the induction control part 106 may induce the hot air to spread in the supply space 105a more rapidly to correspond to the supply hole 151. In addition, since the induction control part 106 has a shape curved away from the supply part 102, the hot air may not flow toward the supply part 102 due to the induction control part 106 after passing between the body part 101 and the induction part 105. Accordingly, the induction control part 106 may maintain the hot air in a state that the hot air spreads over the supply space 105a.

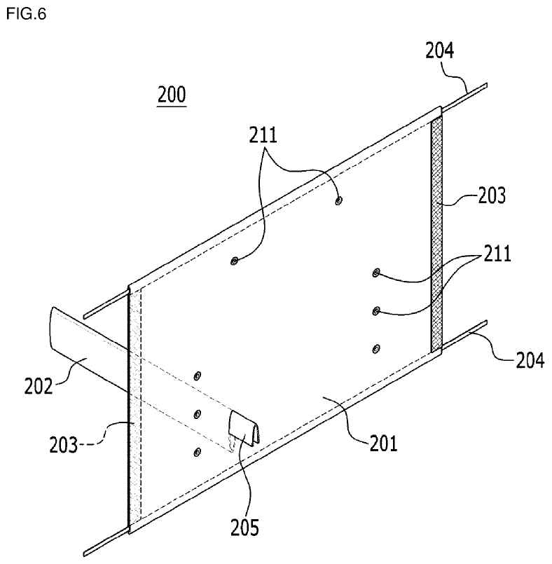

FIG. 6 is a perspective view showing a pet drying jacket 200 according to a second embodiment of the present invention.

As shown in FIG. 6, a pet drying jacket 200 according to a second embodiment of the present invention may include a body part 201, a supply part 202, a coupling part 203, an adjustment part 204, and an induction part 205, and may be used to dry a pet. Since the body part 201, the supply part 202, the coupling part 203, and the adjustment part 204 according to the present embodiment are substantially the same as the body part 101, the supply part 102, the coupling part 103, and the adjustment part 104 according to the first embodiment, respectively, detailed descriptions thereof will be omitted. Meanwhile, although the pet drying jacket 200 according to the present embodiment shown in FIG. 6 may be used to dry the pet without the induction part 205, the damage to the skin of the pet that may occur, such as a burn, may be prevented by the induction part 205. In this case, since the induction part 205 according to the present embodiment has a configuration different from the configuration of the induction part 105 according to the first embodiment, the present embodiment will be described focusing on the induction part 205.

The induction part 205 may be located on an inner surface of the body part 201, may be connected to the supply part 202, and may have a curved shape corresponding to a curvature of the supply part 202. In addition, the induction part 205 may be formed of a flexible fibrous material, which may overlap or may be agglomerated. The induction part 205 may be formed of a material that does not allow air to pass therethrough, and may be formed of synthetic fibers.

While the body part 201 surrounds the pet, the induction part 205 may be located between the supply part 202 and the pet. In this case, when the hot air supplier 200 is connected to the supply part 202 to supply the hot air to the supply part 202, a significant amount of hot air may be discharged through the body rear opening, and the remaining hot air may spread between the pet and the body part 201 without directly reaching the pet due to the induction part 205. Accordingly, the hot air may not be concentrated only at a region of the pet adjacent to a connection portion between the supply part 202 and the body part 201. Therefore, the induction part 205 may evenly supply the hot air to the pet, so that the pet may be dried more evenly, and the damage to the skin of the pet due to concentration of the hot air at a specific region may be prevented.

Although the technical idea of the present invention has been described in detail with reference to preferred embodiments, the technical idea of the present invention is not limited to the above embodiments, and various changes and modifications may be made by those skilled in the art without departing from the scope of the technical idea of the present invention.

### INDUSTRIAL APPLICABILITY

The present invention relates to a pet drying jacket that allows a pet to be easily dried after the pet takes a bath, and may be applied to pet products.

1. A pet drying jacket comprising:
a body part having a sheet shape, and having a plurality of discharge holes; and
a supply part having a pipe shape, and connected to an outer surface of the body part,
wherein, while the body part surrounds a pet such that body openings are formed at opposite lateral ends of the body part, hot air is supplied between the body part and the pet through the supply part to dry the pet, and discharged through the discharge holes and the body openings.

2. The pet drying jacket of claim 1, wherein the body part has a rectangular sheet shape,
the pet drying jacket further comprises:
a pair of coupling parts located at opposite longitudinal end portions of the body part, respectively, while being spaced apart from each other; and
adjustment parts located at opposite lateral end portions of the body part, respectively, to intersect the coupling parts while being spaced apart from each other, and configured to expand and contract the opposite lateral end portions of the body part, and,
while the body part surrounds the pet such that the body openings are formed at the opposite lateral ends of the body part, the coupling parts are coupled to each other, and the adjustment parts adjust sizes of the body openings by expanding and contracting the opposite lateral end portions of the body part, respectively.

3. The pet drying jacket of claim 2, wherein the adjustment part includes:
adjustment guide parts having a string shape, and located along the opposite lateral end portions of the body part to pass through the body part, respectively; and
an adjustment body part through which the adjustment guide part having opposite longitudinal ends connected to each other passes, and configured to expand and contract the opposite lateral end portions of the body part by moving along the adjustment guide part,
an adjustment stopper is located on the adjustment guide part, and,
when the adjustment body part makes contact with the adjustment stopper by moving along the adjustment guide part, the adjustment stopper restricts the movement of the adjustment body part, which contracts the opposite lateral end portions of the body part.

4. The pet drying jacket of claim 1, further comprising an induction part having a sheet shape, having a plurality of supply holes, and located on an inner surface of the body part to form a supply space connected to the supply part,
wherein, while the body part surrounds the pet, the hot air is supplied to the supply space through the supply part, and supplied between the body part and the pet through the supply hole.

5. The pet drying jacket of claim 4, further comprising an induction control part located between the supply holes and between the body part and the induction part, having a predetermined width, extending from the induction part so as to be bent away from the supply part, and making contact with the inner surface of the body part,
wherein, when the hot air is supplied from the supply part to the supply space, the hot air flows away from the supply part to reach the induction control part so as to separate the induction control part from the inner surface of the body part, and passes between the induction control part and the body part.

6. The pet drying jacket of claim 1, further comprising an induction part having a curved shape corresponding to a curvature of the supply part, located on an inner surface of the body part, and connected to the supply part,
wherein, while the body part surrounds the pet, the induction part is located between the supply part and the pet.

7. The pet drying jacket of claim 1 or 6, wherein, while the body part surrounds the pet such that the body openings are formed at the opposite lateral ends of the body part, the supply part is connected to the outer surface of the body part adjacent to the body opening toward which a tail of the pet is directed.
